(19) United States
(12) Patent Application Publication
(10) Pub. No.: US 2018/0079464 A1
(43) Pub. Date: Mar. 22, 2018

(54) COMPACT FRONT WHEEL DRIVE BICYCLE

(71) Applicant: Alex Morgan Bell, New York, NY (US)

(72) Inventor: Alex Morgan Bell, New York, NY (US)

(21) Appl. No.: 15/267,369

(22) Filed: Sep. 16, 2016

(51) Int. Cl. B62K 21/10; B62K 3/10; B62K 3/14; B62K 21/02

(52) U.S. Cl. CPC B62K 21/10; B62K 3/10; B62K 2201/00; B62K 21/02; B62K 3/14

(57) ABSTRACT

One embodiment of a compact front wheel drive cycle in which the front steerable fork is connected to the frame via a spring. And in addition, the rear fork is attached to the frame via a freely rotating caster pivot. Other embodiments are described and shown.

### CROSS-REFERENCE TO RELATED APPLICATIONS

This application claims the benefit of provisional patent application Ser. No. 62222203, filed 2015 Sep. 22 by the present inventor.

### BACKGROUND

### Prior Art

The following is a tabulation of some prior art that presently appears relevant:

U.S. Patents

| Patent Number | Kind Code | Issue Date | Patentee |
|---|---|---|---|
| 20110181014 | B2 | 3 Sep. 2013 | Ryan et al. |

The popularity of cycling has stood the test of time. Mass cycling began with the ‘Penny Farthing’ which had a large direct drive pedal front wheel and a smaller rear wheel. The Penny Farthing had many issues, two of which were the de-stabilizing effect of the pedal pressure on steering and the gearing requirements due to direct drive. The Penny Farthing was replaced in popularity by the so called Safety Bicycle which solved this issue of steering by separating the drive wheel from the steering wheel and introducing gear ratios in the transmission to separate wheel size from torque requirements. However, the safety bicycle has some issues which inconvenience the bicycle for the modern rider such as length of bicycle and complexity of parts.

Many bicycle designs have been proposed which draw on some of the benefits of the Penny Farthing such as U.S. Pat. No. 0,181,014 (2011) to Ryan et al which termed their invention the “mini-farthing” for its smaller size. While the cycles achieve a smaller size they retain the de-stabilizing effect of pedal strokes which resist steering and make the cycle difficult to control.

### SUMMARY

In accordance with one embodiment a bicycle with a large front drive wheel in a steering fork pivoting through the frame, a centering spring connected from the steering fork to the frame, and a rear wheel on a caster also known as pivoted trailing arm which is free to rotate.

### Advantages

While other typical bicycles have utilized centering springs on the steering forks and other Penny Farthing type cycles such as U.S. Pat. No. 0,181,014 (2011) to Ryan et al in FIG. 35a detail a caster rear frame they do not include the combination of centering spring and caster. Without the combination the cycle is unrideable. When both aspects of a design are combined the de-stabilizing effect of the pedal on steering is eliminated. The addition of a centering spring on the steerable fork and castering rear assembly can also be applied to a tandem bicycle where the rear wheel mentioned above is replaced by additional drive wheel for an additional rider.

Drawings - Reference Numerals

| | |
|---|---|
| 1 | Front Wheel |
| 2 | Pedals |
| 3 | Handlebars |
| 4 | Seat |
| 5 | Fork Pivot |
| 6 | Frame |
| 7 | Spring |
| 8 | Caster Pivot |
| 9 | Rear Wheel |
| 10 | Front Fork |
| 11 | Rear Fork |

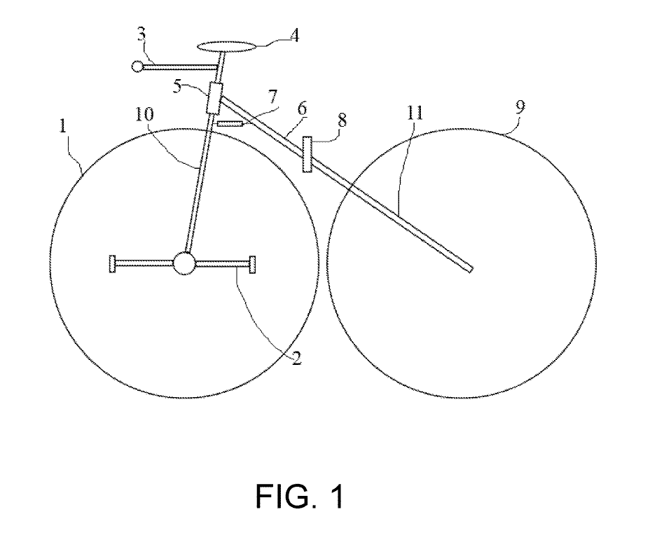

### DETAILED DESCRIPTION—FIG. 1—FIRST EMBODIMENT

One embodiment of the cycle is illustrated in FIG. 1. (Side View.) The front wheel 1 is connected to the steerable fork 10. The pedals 2 are connected to the front wheel. In one embodiment the connection between the pedals and the front wheel are direct. However, the pedals can be connected to the front wheel through a derailleur, gears, planetary gears, or any other type of transmission.The steerable fork is connected to the frame 6 through the fork pivot 5. The steerable fork is also connected to the frame by means of a spring 7. The handlebars 3 are connected to the steerable fork. As pictured the handlebars are in front of the seat, they can also be behind the seat. The seat 4 is connected to the steerable fork. However, the seat can also be attached to the frame. The frame is connected to the rear trailing arm fork also known as caster 11 via the second pivot 8. The rear fork is connected to the rear wheel 9.

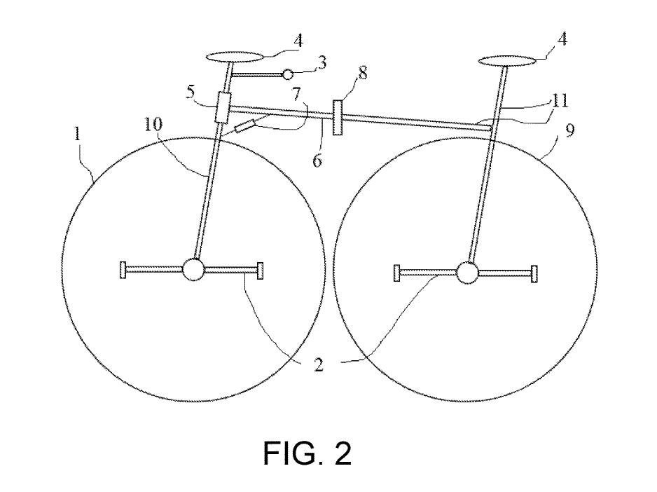

### FIG. 2—Additional Embodiment

Additional embodiment is shown in FIG. 2 in which the rear wheel 9 has the addition of another set of pedals 2, seat 4 and handlebars 3. This embodiment allows for the addition of another rider to the cycle. Alternatively, the pattern of rear castor pivot, additional wheel, seat, pedals, and handlebar can be repeated so as to create a chain of riders on one cycle.

### Operation—FIGS. 1, 2

The cycle is ridden in the same manner as cycles in current use. The rider sits on the seat and uses the handlebars to steer the cycle in the direction of intended travel. As is in the current use the pedals are rotated in order to propel the cycle forward. As the user pedals and steers, any de-stabilizing effect of the pedal pressure is canceled by the rear fork pivot which is deflected slightly in order to assist steering. The user does not actively steer the rear fork, instead the spring interacts with the frame to continuously adjust the position of the frame underneath the rider. In FIG. 2 with the addition of another seat the cycle becomes a tandem device which allows two users to ride the cycle as in the use of current tandem cycles.

### Conclusion, Ramifications, and Scope

Accordingly, the reader will see that the cycle contains few parts and has a compact length. In addition, the reader can see that the addition of the rear pivot in addition to the spring removes the de-stabilizing effect of the front wheel being propelled and solves one of the challenging issues with the Penny Farthing type configuration.

1. (canceled)

2. (canceled)

3. (canceled)

4. A cycle, comprising:
a front wheel configured to rotate in the vertical plane inside a front fork;
a set of pedals attached to the front wheel and configured for a user to propel the cycle by rotation of the pedals;
the front fork is connected to a frame and is configured to rotate in the horizontal plane;
the front fork is configured to be steered by a user by means of a handlebar which is rigidly connected to the front fork;
a seat configured for a user to sit on is directly fixed to the frame;
a rear wheel rotates in the vertical plane inside a rear fork;
the rear fork is connected to the frame through a pivot which is configured to allow the free and non-steered rotation of the rear fork in the horizontal plane;
the cycle is configured such that the only connection between the handlebars and the rear fork must pass through the pivot;
a spring is connected from the front fork to the frame and configured to remove the destabilizing effects of the pedal strokes.
